(19) United States
(12) Patent Application Publication
(10) Pub. No.: US 2021/0132636 A1
(43) Pub. Date: May 6, 2021

(54) SYSTEM FOR MEASURING FLUID CHARACTERISTICS

(71) Applicant: Loon LLC, Mountain View, CA (US)

(72) Inventor: Mathew Tabor, San Francisco, CA (US)

(21) Appl. No.: 16/674,293

(22) Filed: Nov. 5, 2019

(51) Int. Cl. G05D 7/06; G01F 1/84; G01F 1/44; G01F 25/00; G01N 9/32

(52) U.S. Cl. CPC G05D 7/0623; G01F 1/8477; G01F 1/44; G05D 7/0635; G01F 1/8436; G01N 9/32; G01F 25/0007

(57) ABSTRACT

Aspects of the disclosure relate measuring fluid characteristics and controlling operation of a first valve. An example system may include the first valve, a regulator valve, a critical flow venturi, and a Coriolis flow meter. The critical flow venturi may be arranged on a flow path between the regulator valve and the Coriolis flow meter. The system may also include one or more processors configured to receive a density measurement from the Coriolis flow meter and use the density measurement from the Coriolis flow meter to control operation of the first valve. The one or more processors may also be configured to use the density measurement to determine a lift force of gas in an envelope and to control the operation of the first value further based on the determined lift force.

### BACKGROUND

Computing devices such as personal computers, laptop computers, tablet computers, cellular phones, and countless types of Internet-capable devices are increasingly prevalent in numerous aspects of modern life. As such, the demand for data connectivity via the Internet, cellular data networks, and other such networks, is growing. However, there are many areas of the world where data connectivity is still unavailable, or if available, is unreliable and/or costly. Accordingly, additional network infrastructure is desirable.

Some systems may provide such additional network access via high-altitude platforms such as balloons and other aerial vehicles operating in the stratosphere. These platforms may utilize an envelope which enables the aerial vehicle to float in the stratosphere. Typically, in order to ensure that sufficient lift forces are achieved in an envelope, operators may fill the envelope to a desired amount under the assumption that the density of helium in the fluid used to fill the envelope is 100%. Of course, this requires that operators use only very high purity helium, for instance, on the order of 99.999% helium.

### BRIEF SUMMARY

One aspect of the disclosure provides a system for measuring fluid characteristics and controlling operation of a first valve. The system includes a regulator valve for regulating flow of a fluid; the first valve; a critical flow venturi; and a Coriolis flow meter. The critical flow venturi is arranged on a flow path between the regulator valve and the Coriolis flow meter. The system also includes one or more processors configured to receive a density measurement from the Coriolis flow meter and use the density measurement from the Coriolis flow meter to control operation of the valve.

In one example, the one or more processors are further configured to use the density measurement to determine a lift force of gas in an envelope, and to control the operation of the first value further based on the determined lift force. In this example, the one or more processors are further configured to receive user input identifying a desired lift force and control the operation of the first valve further based on the determined lift force. In addition, the one or more processors are further configured to control the operation of the first valve by closing the first valve when the determined lift force is at least the desired lift force. In another example, the one or more processors are further configured to receive a mass flow rate from the critical flow venturi, receive a mass flow rate from the Coriolis flow meter, and compare the mass flow rate from the critical flow venturi to the mass flow rate from the Coriolis flow meter in order to calibrate the Coriolis flow meter. In another example, the critical flow venturi is arranged to change the pressure of gas passing through the critical flow venturi from a first pressure to a second pressure, the one or more processors are further configured to receive a mass flow rate from the Coriolis flow meter, determine a second mass flow rate using the density measurement and second pressure, and compare the second mass flow rate to the mass flow rate from the Coriolis flow meter in order to calibrate the Coriolis flow meter. In another example, the system also includes a gas source in fluid communication with the regulator valve. In another example, the system also includes the envelope.

Another aspect of the disclosure provides a method for measuring fluid characteristics and controlling operation of a first valve in a system including a flow path from a regulator valve to a critical flow venturi to a Coriolis flow meter. The method includes receiving a density measurement from the Coriolis flow meter, and using the density measurement from the Coriolis flow meter to control operation of the first valve.

In one example, the flow path further includes an envelope arranged after the Coriolis flow meter, and the method also includes using the density measurement to determine a lift force of gas in the envelope, and controlling the operation of the first value further based on the determined lift force. In this example, the method also includes receiving, at the one or more processors, user input identifying a desired lift force, and wherein controlling the operation of the first valve further based on the desired lift force. In addition, the method also includes controlling the operation of the first valve by having the one or more processors sending a signal to close the first valve when the determined lift force is at least the desired lift force. In another example, the method also includes receiving a mass flow rate from the critical flow venturi, receiving a mass flow rate from the Coriolis flow meter, and comparing the mass flow rate from the critical flow venturi to the mass flow rate from the Coriolis flow meter in order to calibrate the Coriolis flow meter. In another example, the critical flow venturi is arranged to change the pressure of gas passing through the critical flow venturi from a first pressure to a second pressure, and the method also includes receiving a mass flow rate from the Coriolis flow meter, determining a second mass flow rate using the density measurement and second pressure, and comparing the second mass flow rate to the mass flow rate from the Coriolis flow meter in order to calibrate the Coriolis flow meter.

### BRIEF DESCRIPTION OF THE DRAWINGS

FIG. 1 is an example network of aerial vehicles in accordance with aspects of the disclosure.

FIG. 2 is an example of an aerial vehicle in accordance with aspects of the present disclosure.

FIG. 3 is an example of an aerial vehicle in flight in accordance with aspects of the disclosure.

FIG. 4 is an example diagram of a system for measuring fluid characteristics and controlling operation of a first valve in accordance with aspects of the disclosure.

FIG. 5 is an example diagram of a control system in accordance with aspects of the disclosure.

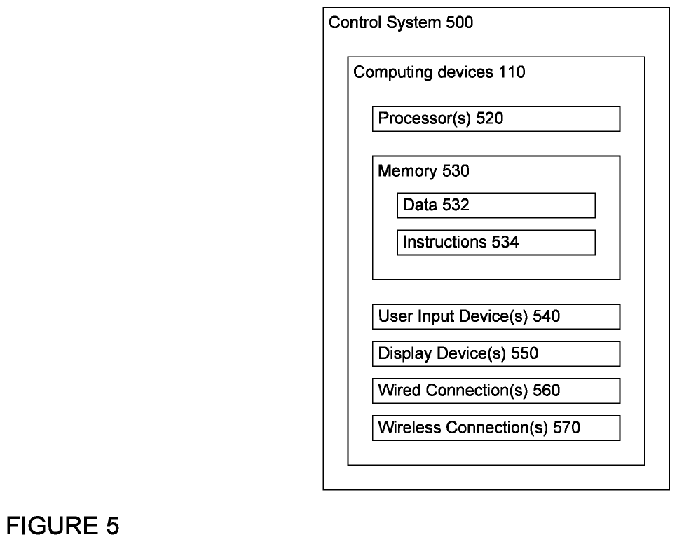

FIG. 6 is a flow diagram in accordance with aspects of the disclosure.

### DETAILED DESCRIPTION

### Overview

The present disclosure generally relates to systems for filling envelopes, such as those used with aerial vehicles, with lift gas. The costs of lift gasses such as helium increases as the purity levels of such gases increases. Typically, in order to ensure that sufficient lift forces are achieved in an envelope, operators may fill the envelope to a desired amount under the assumption that the density of helium in the fluid used to fill the envelope is 100%. Of course, this requires that operators use only very high purity helium, for instance, on the order of 99.999% helium.

In order to avoid the need for such high-purity helium, a system may enable operators to more directly measure the characteristics of a fluid and thereby the lift force of the fluid in the envelope may be used. For instance, a fluid, such as a gas, from a gas source flows through a regulator valve. At this point, the gas is at a certain pressure and temperature. The gas then flows through a critical flow venturi or nozzle. This critical flow venturi may be used measure a mass flow rate of gas through an orifice in the critical flow venturi by taking pressure ratings before and after the critical flow venturi. After the critical flow venturi, the gas may pass through a Coriolis flow meter. The Coriolis flow meter may use vibrating tubes and resonant frequency to get both a mass flow rate and density measurement of the gas. The position of the critical flow venturi upstream from the Coriolis flow meter may provide both a very stable pressure and may also allow for in-line calibration of the Coriolis flow meter as discussed further below.

In use, an operator may enter a desired lift force into a control system which can control the flow of gas to the envelope. The control system may determine the density from feedback from the Coriolis flow meter and use this in combination with the mass flow rate and the time that gas has been flowing through the system to determine when the desired lift force has been reached at which point, the computer can send a signal to a valve and stop the flow of gas into the envelope. At this point, the envelope may be disconnected from the system, and for instance, launched or used for other purposes. In some instances, the control system may be able to determine exactly what gasses make up the gas flowing through the system.

As noted above, both the Coriolis flow meter and the critical flow venturi may provide a mass flow rate. The Coriolis will always measure true mass in the tubes, regardless of the gas species. The critical flow venturi, on the other hand, will shift based on the gas flowing through it and will need to be reprogrammed for a foreign gas. These two mass flow rate measurements can be compared in order to calibrate either meter.

The features described herein may enable operators to measure characteristics of the lift the gasses put into an envelope directly and thereby to more directly calculate the lift force of the gas put into the envelope. As such, the system may enable an operator to enter a desired lift force and the system will automatically stop the flow of gas into the envelope. This may allow for some significant advantages, including that operators have a more accurate idea of the contents in the envelope and may also enable the use of less costly lift gas (i.e. helium that is less pure). For example, a similar lift force can be achieved with a lower purity helium (such as 97% helium and 3% of unknown gas) when greater amounts of the gas is used as compared to a more pure helium of 99% or greater. When considering this difference over a plurality of aerial vehicles which may be utilized in a network such as network 100, this can be a significant savings in both costs and the amount of pure helium utilized. As a result, the system can reduce the impact of these aerial vehicles on the global helium supply. This can also help keep meters in calibration over time by comparing two methods with different operating principles.

### Example Network

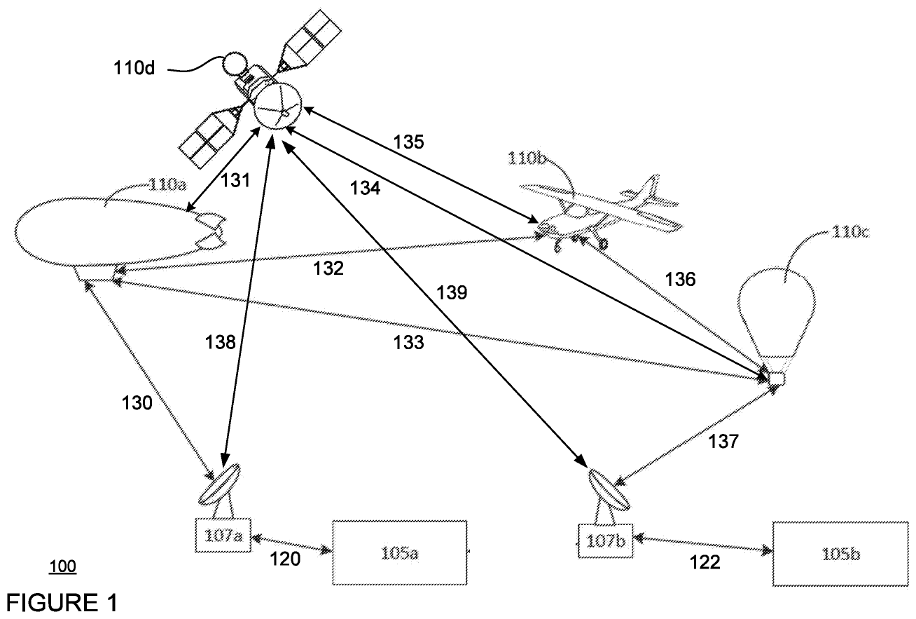

FIG. 1 is a block diagram of an example directional point-to-point network 100. The network 100 is a directional point-to-point computer network consisting of nodes mounted on various land- and air-based devices, some of which may change position with respect to other nodes in the network 100 over time. For example, the network 100 includes nodes associated with each of two land-based datacenters 105a and 105b (generally referred to as datacenters 105), nodes associated with each of two ground stations 107a and 107b (generally referred to as ground stations 107), and nodes associated with each of four airborne high altitude platforms (HAPs) 110a-110d (generally referred to as HAPs 110). As shown, HAP 110a is an aerial vehicle (here depicted as a blimp), HAP 110b is an airplane, HAP 110c is an aerial vehicle (here depicted as a balloon), and HAP 110d is a satellite. In some embodiments, nodes in network 100 may be equipped to perform FSOC, making network 100 an FSOC network. Additionally or alternatively, nodes in network 100 may be equipped to communicate via radio-frequency signals or other communication signal capable of travelling through free space. Arrows shown between a pair of nodes represent possible communication links 120, 122, 130-137 between the nodes. The network 100 as shown in FIG. 1 is illustrative only, and in some implementations the network 100 may include additional or different nodes. For example, in some implementations, the network 100 may include additional HAPs, which may be balloons, blimps, airplanes, unmanned aerial vehicles (UAVs), satellites, or any other form of high-altitude platform.

In some implementations, the network 100 may serve as an access network for client devices such as cellular phones, laptop computers, desktop computers, wearable devices, or tablet computers. The network 100 also may be connected to a larger network, such as the Internet, and may be configured to provide a client device with access to resources stored on or provided through the larger computer network. In some implementations, HAPs 110 can include wireless transceivers associated with a cellular or other mobile network, such as eNodeB base stations or other wireless access points, such as WiMAX or UMTS access points. Together, HAPs 110 may form all or part of a wireless access network. HAPs 110 may connect to the datacenters 105, for example, via backbone network links or transit networks operated by third parties. The datacenters 105 may include servers hosting applications that are accessed by remote users as well as systems that monitor or control the components of the network 100. HAPs 110 may provide wireless access for the users, and may route user requests to the datacenters 105 and return responses to the users via the backbone network links.

### Example Aerial Vehicle

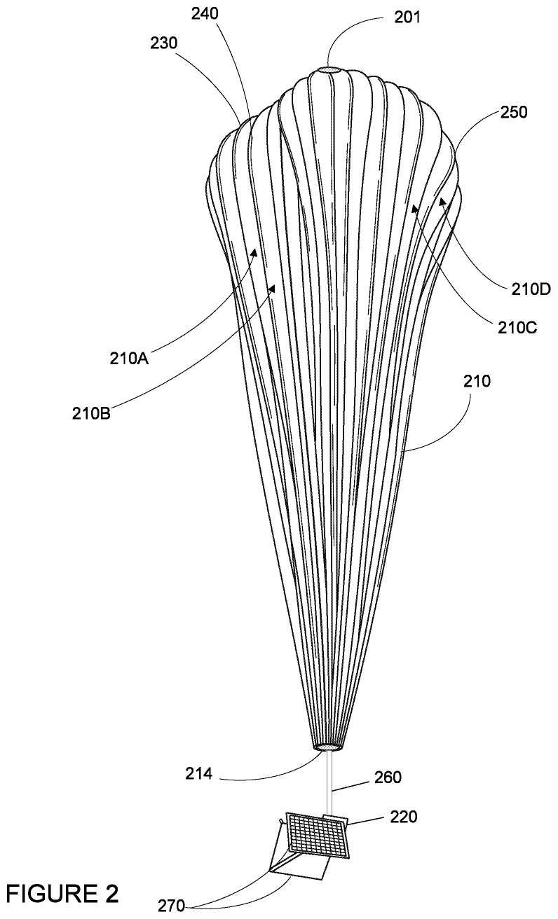

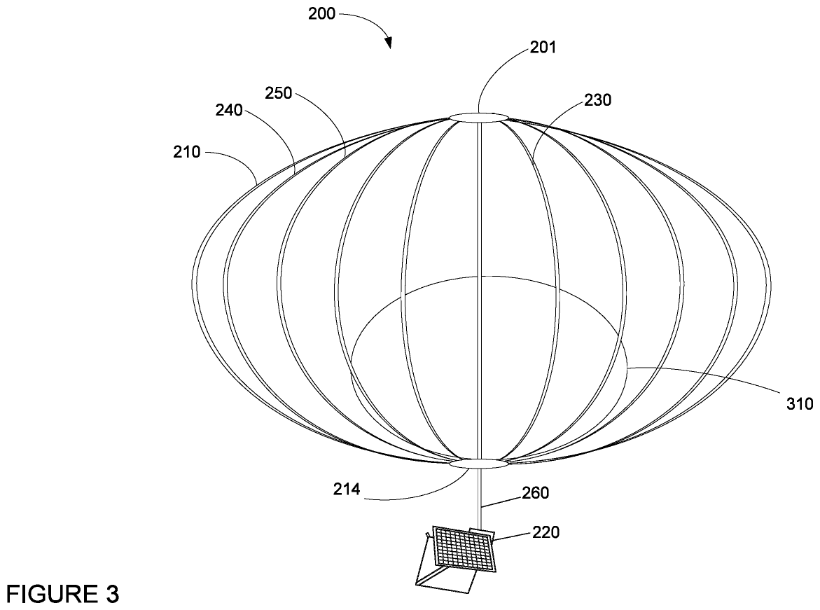

FIGS. 2 and 3 are examples of an aerial vehicle 200 which may correspond to HAP 110c, again, depicted here as a balloon. For ease of understanding, the relative sizes of and distances between aspects of the aerial vehicle 200 and ground surface, etc. are not to scale. As shown, the aerial vehicle 200 includes an envelope 210, a payload 220 and a plurality of tendons 230, 240 and 250 attached to the envelope 210. The envelope 210 may take various forms. In one instance, the envelope 210 may be constructed from materials (i.e. envelope material) such as polyethylene that do not hold much load while the aerial vehicle 200 is floating in the air during flight. Additionally, or alternatively, some or all of envelope 210 may be constructed from a highly flexible latex material or rubber material such as chloroprene. Other materials or combinations thereof may also be employed. Further, the shape and size of the envelope 210 may vary depending upon the particular implementation. Additionally, the envelope 210 may be filled with various gases or mixtures thereof, such as helium, or any other lighter-than-air gas. The envelope 210 is thus arranged to have an associated upward buoyancy force during deployment of the payload 220.

The payload 220 of aerial vehicle 200 may be affixed to the envelope by a connection 260 such as a cable or other rigid structure. The payload 220 may include a computer system (not shown), having one or more processors and on-board data storage. The payload 220 may also include various other types of equipment and systems (not shown) to provide a number of different functions. For example, the payload 220 may include various communication systems such as optical and/or RF, a navigation software module, a positioning system, a lighting system, an altitude control system (configured to change the altitude of the aerial vehicle in order to follow navigation instructions), a plurality of solar panels 270 for generating power, and a power supply to store power generated by the solar panels. The power supply may also supply power to various components of aerial vehicle 200.

In view of the goal of making the envelope 210 as lightweight as possible, it may be comprised of a plurality of envelope lobes or gores that have a thin film, such as polyethylene or polyethylene terephthalate, which is lightweight, yet has suitable strength properties for use as an envelope. In this example, envelope 210 is comprised of envelope gores 210A-D.

Pressurized lift gas within the envelope 210 may cause a force or load to be applied to the aerial vehicle 200. In that regard, the tendons 230, 240, 250 provide strength to the aerial vehicle 200 to carry the load created by the pressurized gas within the envelope 210. In some examples, a cage of tendons (not shown) may be created using multiple tendons that are attached vertically and horizontally. Each tendon may be formed as a fiber load tape that is adhered to a respective envelope gore. Alternately, a tubular sleeve may be adhered to the respective envelopes with the tendon positioned within the tubular sleeve.

Top ends of the tendons 230, 240 and 250 may be coupled together using an apparatus, such as top plate 201 positioned at the apex of envelope 210. A corresponding apparatus, e.g., base plate or bottom plate 214, may be disposed at a base or bottom of the envelope 210. The top plate 201 at the apex may be the same size and shape as and bottom plate 214 at the bottom. Both caps include corresponding components for attaching the tendons 230, 240 and 250 to the envelope 210.

FIG. 3 is an example of the aerial vehicle 200 in flight when the lift gas within the envelope 210 is pressurized. In this example, the shapes and sizes of the envelope 210, connection 260, envelope 310, and payload 220 are exaggerated for clarity and ease of understanding. During flight, these balloons may use changes in altitude to achieve navigational direction changes. In this regard, the envelope 310 may be a ballonet that holds ballast gas (e.g., air) therein, and the envelope 210 may hold lift gas around the ballonet. For example, the altitude control system of the payload 220 may cause air to be pumped into a ballast within the envelope 210 which increases the mass of the aerial vehicle and causes the aerial vehicle to descend. Similarly, the altitude control system may cause air to be released from the ballast (and expelled from the aerial vehicle) in order to reduce the mass of the aerial vehicle and cause the aerial vehicle to ascend. Alternatively, in a reverse ballonet configuration, the envelope 310 may hold lift gas therein and the envelope 210 may hold ballast gas (e.g., air) around the envelope 310, and the envelope 310 may hold the lift gas therein. In either case, the envelope 310 may be attached to one or both of the top plate 201 or the bottom plate 214 (attachment to the bottom plate being depicted in FIG. 3).

### Example System

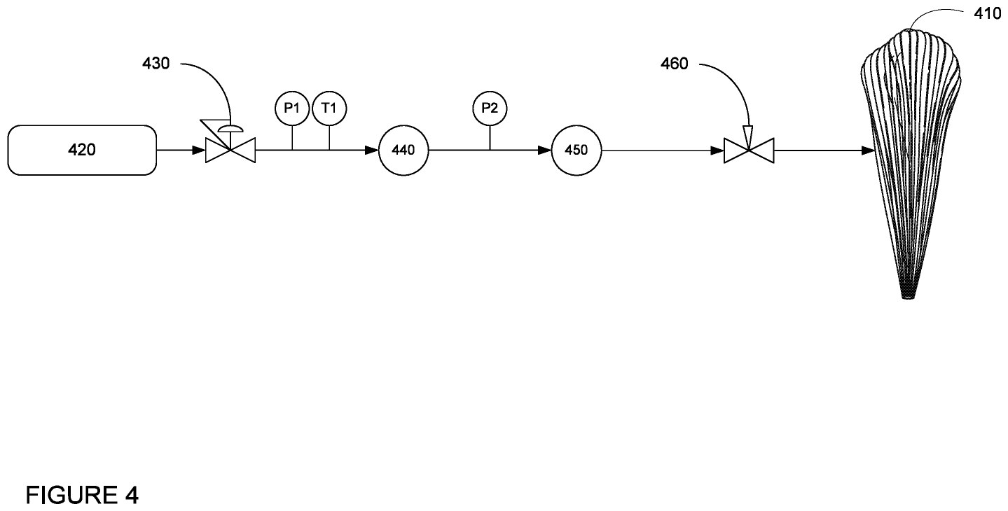

FIG. 4 provides an example of a system 400 for measuring fluid characteristics and controlling operation of a first valve. The system 400 may enable measurement of characteristics of a fluid before it reaches an envelope 410 which may correspond to envelope 210 or another object configured to hold the fluid. The system 400 includes a flow path (indicated by arrows in FIG. 4) for the fluid from a gas source 420 (e.g. a tank), through a regulator valve 430, through a critical flow venturi 440, through a Coriolis flow meter 450, through a flow control valve 460, and into the envelope 410. In this regard, the arrows may represent hoses or tubing of an appropriate length and materials (e.g. plastics, metals, etc.) connecting each of the devices. When the flow control and regulator valve are open, each of the gas source 420, regulator valve 430, critical flow venturi 440, Coriolis flow meter 450, and flow control valve 460 are in fluid communication with one another.

Following the flow path of FIG. 4, the fluid, here a gas, from the gas source 420 flows through a regulator valve 430. The regulator valve 430 may function as a control valve to reduce the pressure of the gas from the gas source to a desired pressure. At this point, the gas is at a certain pressure (P1) and temperature (T1). From the regulator valve 430, the gas then flows through a critical flow venturi 440 or nozzle. The critical flow venturi may change the pressure of gas entering the critical flow venturi to another pressure as the gas exits the critical flow venturi. This critical flow venturi may also measure the flow of gas through an orifice in the critical flow venturi by taking pressure ratings before (P1 or a first pressure when gas enter the critical flow venturi) and after (P2 or a second pressure when gas exits the critical flow venturi) the critical flow venturi. Feedback from the critical flow venturi including the pressure ratings P1 and P2 may be provided to a control system 500 for instance, via a wired or wireless connection, for instance, by sending the feedback as a signal (e.g. direct current or voltage signal) via a transmitter of the critical flow venturi to a receiver of the control system. Such signals may be sent via a serial BUS system and/or using short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

After the critical flow venturi 440, the gas may pass through a Coriolis flow meter 450. The Coriolis flow meter may use vibrating tubes and resonant frequency to get both a mass flow rate and density measurement of the gas. The position of the critical flow venturi upstream from the Coriolis flow meter may provide both allow for in-line calibration of the Coriolis flow meter as discussed further below and may provide a very stable pressure for the gas. In other words, the pressure P2 may be generally constant. Feedback from Coriolis flow meter including the mass flow rate and density measurements may be provided to the control system 500 for instance, via a wired or wireless connection, for instance, by sending the feedback as a signal via a transmitter of the Coriolis flow meter to a receiver of the control system. Again, such signals may be sent via a serial BUS system and/or using short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

As noted above, the Coriolis flow meter 450 may provide both a mass flow rate and density of the gas. The Coriolis flow meter may include two u-shaped tubes which oscillate in phase when no fluid is flowing through the tubes. As fluid flows through the tubes, the inlet and outlet rube frequency curves shift, creating a phase difference. This phase difference can be measured and is directly proportional to the mass flow rate. Density can also be measured through the tubes using the frequency of the vibrations of the tubes of the Coriolis flow meter. For instance, the frequency of the sine wave is proportional to the density of the gas in the tubes, and as such, by measuring this frequency, the density can be determined. The denser the gas, the lower the frequency of the vibrations of the tubes will be (similar to two different masses oscillating on the same spring).

Because the density of any compressible gas, such as Helium, will change with pressure, it is useful to precisely control the upstream pressure of the Coriolis flow meter for accurate measurement. To address this, the critical flow venturi 440 may provide a steady or constant pressure at P2. Alternatively, rather than using the critical flow venturi 440, a second regulator valve could be used or one could calculate the average of the density at the Coriolis flow meter 450 over time.

From the Coriolis flow meter, the gas then flows to the flow control valve 460, and if the flow control valve is open, thereafter into the envelope 410. If the flow control valve is closed, the gas is unable to flow into the envelope. The opening and closing of the flow control valve 460 may be controlled by signals from a control system 500 (discussed further below) for instance, via a wired or wireless connection, for instance, by receiving signals via a receiver of the valve from a transmitter of the control system. Again, such signals may be sent via a serial BUS system and/or using short range communication protocols such as Bluetooth, Bluetooth low energy (LE), cellular connections, as well as various configurations and protocols, including the Internet, World Wide Web, intranets, virtual private networks, wide area networks, local networks, private networks using communication protocols proprietary to one or more companies, Ethernet, WiFi and HTTP, and various combinations of the foregoing.

### Example Control System

Operation of the system may be controllable by a control system. For instance, a control system 500 may include one or more computing devices 510 including one or more processors 520, memory 530, one or more user input devices 540, one or more display devices 550, and other components typically present in general purpose computing devices.

The memory 530 may store information accessible by the one or more processors 520, including instructions 534 and data 532 that may be executed or otherwise used by the processors 520. The memory 530 may be of any type capable of storing information accessible by the one or more processors, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 534 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 532 may be retrieved, stored or modified by the one or more processors 520 in accordance with the instructions 534. For instance, although the claimed subject matter is not limited by any particular data structure, the data may be stored in computing device registers, in a relational database as a table having a plurality of different fields and records, XML documents or flat files. The data may also be formatted in any computing device-readable format. For instance, data may store information about the expected location of the sun relative to the earth at any given point in time as well as information about the location of network targets.

The one or more processors 520 may be any conventional processors, such as commercially available CPUs or GPUs. Alternatively, the one or more processors may be a dedicated device such as an ASIC or other hardware-based processor. Although FIG. 9 functionally illustrates the processor 520, memory 530, and other elements of the control system 500 as being within the same block, it will be understood that the processors or memory may actually include multiple processors or memories that may or may not be stored within the same physical housing. For example, memory may be a hard drive or other storage media located in a housing different from that of the control system 500.

The user input devices 540 may include a mouse, mousepad, camera, keyboard, touchscreen, microphone or other devices that may enable a human operator, to provide input to the computing devices 510 as described herein. The display device 550 may include a monitor having a screen, a touch-screen, a projector, a television, or other device that is operable to display information to a human operator as described herein.

The control system 500 may also include one or more wired connections 560 and wireless connections 570 (such as transmitters/receivers) to facilitate communication with other devices, such as the regulator valve 430, critical flow venturi 440, Coriolis flow meter 450. As an example, the wireless network connections may include short range communication protocols such as Bluetooth, Bluetooth low energy (LE), cellular connections, as well as various configurations and protocols, including the Internet, World Wide Web, intranets, virtual private networks, wide area networks, local networks, private networks using communication protocols proprietary to one or more companies, Ethernet, WiFi and HTTP, and various combinations of the foregoing.

In use, an operator may enter a desired lift force for the envelope 410 (or 210) into computing device 110 of the control system 500, for instance, via one of the user input devices 540. In this regard, the computing devices 510 may receive user input identifying a desired lift force.

The computing devices 510 (or rather, the processors 520) may determine the density of gas from feedback from the Coriolis flow meter 450 and use this in combination with the mass flow rate from the Coriolis flow meter 450 as well as the time that gas has been flowing through the system 400 to determine the current calculated lift force in the envelope. For instance, the lift force or buoyancy of the envelope may correspond to d*V*g, where d corresponds to the density of the gas, V corresponds to the volume of gas, and g is the constant for gravity. The volume of gas corresponds to d/M, where M is the mass of gas in the envelope. The mass of the gas in the envelope corresponds to the Qm*t less some adjustment value, wherein Qm corresponds to the mass flow rate and t corresponds to the amount of time that gas has been flowing through the regulator valve (i.e. how long the regulator valve has been opened) and into the envelope. The adjustment value may correspond to the mass of gas in the system that the Coriolis flow meter measured but did not actually enter the envelope, or rather, the amount of gas that is in the hoses between the Coriolis flow meter and the envelope. This value may be calculated using the Ideal Gas Law, PV=nRT (know Pressure, Volume, Temperature, R is a constant, and “n” Number of moles of gas corresponding to the adjustment value). In this regard, the mass flow rate can be used to determine the lift force in the envelope using the equation d²*g/(Qm*t).

The computing devices 510 (or rather, the processors 120) may also determine when the desired lift force has been reached by comparing the current calculated lift force in the envelope to the desired lift force. Once the current calculated lift force in the envelope is equal to the desired lift force, the computing device 510 may send a signal to the flow control valve 460 in order to close the flow control valve. Closing the flow control valve 460 may stop the flow of gas into the envelope 410. Thereafter, the envelope 410 may be disconnected from the system 400, for example by crushing a fill port of the aerial vehicle or otherwise sealing the envelope closed, and for instance, launched or used for other purposes. In some instances, the computing devices 510 (or rather, the processors 520) may be able to determine exactly what gasses make up the gas flowing through the system.

The display devices 550 may be used by the computing device 110 in order to display various information about the system 400 including, for example, the mass flow rate from the critical flow venturi 440 and/or the Coriolis flow meter 450, the density from the Coriolis flow meter 450, the state of the regulator valve 430 and control valve 460 (e.g. closed or open and to what degree), the desired lift force, and the current calculated lift force in the envelope.

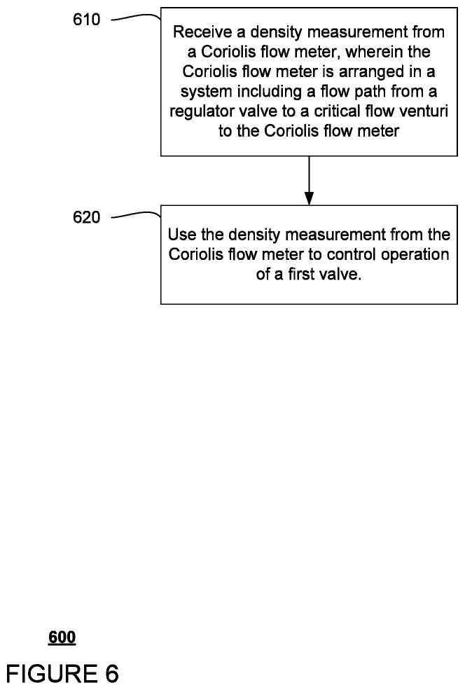

FIG. 6 is an example flow diagram 600 for measuring fluid characteristics and controlling operation of a first valve (e.g. a flow control valve such as flow control valve 460) in a system including a flow path from a regulator valve to a critical flow venturi to a Coriolis flow meter. The flow diagram may be performed by one or more processors of one or more computing devices, such as the processors 520 of the computing devices 510. For instance, at block 610, a density measurement is received from the Coriolis flow meter. As noted above, this may be by wireless or wired connection.

At block 620, the flow rate measurement from the Coriolis flow meter is used to control operation of the first valve. Controlling the first valve or rather, the flow control valve, may include opening (if the flow control valve was previously closed) or closing (if the flow control valve is open and a desired lift force has been reached) the flow control valve by sending a signal to the flow control valve which cases the flow control valve to open or close. In this regard, the computing devices may use the density measurement to determine a lift force of gas in the envelope, and this lift force may be used to control the operation of the flow control value. For instance, if the lift force meets a desired lift force, the flow control valve may be closed. As noted above, this desired lift force may include input into the computing devices 510 via one or more of the user input devices 540 by a human operator.

As noted above, both the Coriolis flow meter and the critical flow venturi may provide a mass flow rate. The Coriolis will always measure true mass in the tubes, regardless of the gas species. The critical flow venturi, on the other hand, will shift based on the gas flowing through it and will need to be reprogrammed for a foreign gas. These two mass flow rate measurements can be compared in order to calibrate either meter. For example, if the measured density matches that of pure helium density (within some predetermined allowable error) and the critical flow venturi 440 will read the true mass flow rate (within some expected error for the critical flow venturi), then the Coriolis flow meter 450 can be calibrated using the mass flow rate provided by the critical flow venturi 440. If the measured density does not match that of pure helium density, the Coriolis flow meter 450 will read true mass flow rate (within some expected error for the Coriolis flow meter), and the critical flow venturi 440's calculated flow coefficients can be recalculated to gather accurate mass flow information for the given gas. The calculated flow coefficients may be determined using a polynomial regression fit based on empirical fluid data, and may therefore be dependent on the type of the gas.

The features described herein may enable operators to measure characteristics of the lift the gasses put into an envelope directly and thereby to more directly calculate the lift force of the gas put into the envelope. As such, the system may enable an operator to enter a desired lift force and the system will automatically stop the flow of gas into the envelope. This may allow for some significant advantages, including that operators have a more accurate idea of the contents in the envelope and may also enable the use of less costly lift gas (i.e. helium that is less pure). For example, a similar lift force can be achieved lower purity helium (such 97% helium and 3% of unknown gas) when greater amounts of the gas is used as compared to a more pure helium of 99% or greater. Although the gas may be unknown, the Coriolis meter enables the determination of the density of the gas and therefore the mass which enables operators to determine how much gas is needed to achieve a desired lift force. When considering this difference over a plurality of aerial vehicles which may be utilized in a network such as network 100, this can be a significant savings in both costs and the amount of pure helium utilized. As a result, the system can reduce the impact of these aerial vehicles on the global helium supply. This can also help keep meters in calibration over time by comparing two methods with different operating principles.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system for measuring fluid characteristics and controlling operation of a first valve, the system comprising:
a regulator valve for regulating flow of a fluid;
the first valve;
a critical flow venturi;
a Coriolis flow meter, wherein the critical flow venturi is arranged on a flow path between the regulator valve and the Coriolis flow meter; and
one or more processors configured to:
receive a density measurement from the Coriolis flow meter; and
use the density measurement from the Coriolis flow meter to control operation of the valve.

2. The system of claim 1, wherein the one or more processors are further configured to use the density measurement to determine a lift force of gas in an envelope, and to control the operation of the first value further based on the determined lift force.

3. The system of claim 2, wherein the one or more processors are further configured to:
receive user input identifying a desired lift force; and
to control the operation of the first valve further based on the determined lift force.

4. The system of claim 3, wherein the one or more processors are further configured to control the operation of the first valve by closing the first valve when the determined lift force is at least the desired lift force.

5. The system of claim 1, wherein the one or more processors are further configured to:
receive a mass flow rate from the critical flow venturi;
receive a mass flow rate from the Coriolis flow meter; and
compare the mass flow rate from the critical flow venturi to the mass flow rate from the Coriolis flow meter in order to calibrate the Coriolis flow meter.

6. The system of claim 1, wherein the critical flow venturi is arranged to change the pressure of gas passing through the critical flow venturi from a first pressure to a second pressure, the one or more processors are further configured to:
receive a mass flow rate from the Coriolis flow meter;
determine a second mass flow rate using the density measurement and second pressure; and
compare the second mass flow rate to the mass flow rate from the Coriolis flow meter in order to calibrate the Coriolis flow meter.

7. The system of claim 1, further comprising a gas source in fluid communication with the regulator valve.

8. The system of claim 1, further comprising the envelope.

9. A method for measuring fluid characteristics and controlling operation of a first valve in a system including a flow path from a regulator valve to a critical flow venturi to a Coriolis flow meter, the method comprising:
receiving, by one or more processors, a density measurement from the Coriolis flow meter; and
using the density measurement from the Coriolis flow meter to control operation of the first valve.

10. The method of claim 9, wherein the flow path further includes an envelope arranged after the Coriolis flow meter, and the method further comprises using the density measurement to determine a lift force of gas in the envelope, and wherein controlling the operation of the first value further based on the determined lift force.

11. The method of claim 9, further comprising, receiving, at one or more processors, user input identifying a desired lift force, and wherein controlling the operation of the first valve further based on the desired lift force.

12. The method of claim 11, further comprising, controlling the operation of the first valve by having the one or more processors sending a signal to close the first valve when the determined lift force is at least the desired lift force.

13. The method of claim 9, further comprising:
receiving a mass flow rate from the critical flow venturi;
receiving a mass flow rate from the Coriolis flow meter; and
comparing the mass flow rate from the critical flow venturi to the mass flow rate from the Coriolis flow meter in order to calibrate the Coriolis flow meter.

14. The method of claim 9, wherein the critical flow venturi is arranged to change the pressure of gas passing through the critical flow venturi from a first pressure to a second pressure, and the method further comprises:
receiving a mass flow rate from the Coriolis flow meter;
determining a second mass flow rate using the density measurement and second pressure; and
comparing the second mass flow rate to the mass flow rate from the Coriolis flow meter in order to calibrate the Coriolis flow meter.
